(19) United States
(12) Patent Application Publication
(10) Pub. No.: US 2003/0037938 A1
(43) Pub. Date: Feb. 27, 2003

(54) Vibratory impactor

(76) Inventor: Ronald H. Hall, Embro (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 09/935,839

(22) Filed: Aug. 24, 2001

(51) Int. Cl. E21B 7/24; B25D 16/00

(52) U.S. Cl. 173/49; 173/212

(57) ABSTRACT

An impacting apparatus and a vehicle having such an apparatus, the apparatus having a mounting portion securable to the vehicle, a tool support portion pivotally connected adjacent a first edge of the tool support portion to the mounting portion via a pivotal connection and flexibly connected at a second edge of the tool support portion to the mounting portion via a flexible connection remote from the pivotal connection, vibration means mounted between the mounting portion and the tool support portion for reciprocating the tool support portion relative the mounting portion via the flexible connection and a tool extending from the tool support portion. The flexible connection comprises resilient elements held by a fastening means between end plates. The fastening means has tightening means for adjusting the flexible connection to a predetermined compression setting of the resilient elements.

### BACKGROUND OF THE INVENTION

1. Field of the Invention

The invention relates to a mount for providing a vibrating impactor/ripper tool while simultaneously reducing vibrations transmitted from the tool to a carrier vehicle, such as a tractor.

2. Description of the Prior Art

In the past, different approaches have been tried to provide a hammer-like tool movement, for instance a hydraulically driven impact hammer while minimizing the transfer of vibrations from the tool to a carrier vehicle. The vibrations generally tire out the vehicle operator and cause the bolted parts of the vehicle to come apart, necessitating re-tightening of these bolts. The wear on the vehicle parts also increases. The vibrating tool, for example an impactor, is generally mounted on an articulated arm having a vibrating means attached to the tool. Examples of this construction are shown in U.S. Pat. No. 5,224,306 (Artzberger) and U.S. Pat. No. 4,984,850 (Jensen). Jensen shows a linear impact ripper with hydraulic activation. The linear ram is resiliently held at one end in the device, to lower vibration transfer to the rest of the construction. The construction is relatively complicated, resulting in an expensive apparatus with associated high maintenance costs. Artzberger shows a vibratory compactor attachment combined with a scraper. This solution has the apparent disadvantage of excessive wear and tear on the vibration dampening means, due to the fact that the tool is vibrating in all directions. This subjects the vibration dampening means to compression (tensile) and shear stress. Most vibration means are rubber pads (or similar material), and inherently much less suited to shear stress, as compared to tensile stress. The vibration dampening means therefor wear out excessively fast in these applications.

### SUMMARY OF THE INVENTION

It is an object of the invention to provide a vibrating impactor/ripper tool for attachment to an articulated arm of a vehicle, the tool having a holder with an improved vibration isolation mount, that prevents the action of shear stress on the vibration dampening means, while the mount successfully isolates a substantial portion of the vibrations generated by a tool attached to a vehicle, and simultaneously providing a high load capacity for the isolation mount.

In the invention, an impacting apparatus for a vehicle comprises a mounting portion securable to the vehicle, a tool support portion pivotally connected adjacent a first edge of the tool support portion to the mounting portion via a pivotal connection and flexibly connected at a second edge of the tool support portion to the mounting portion via a flexible connection remote from the pivotal connection, vibration means mounted between the mounting portion and the tool support portion for reciprocating the tool support portion relative the mounting portion via the flexible connection and a tool extending from the tool support portion.

Advantageously, the flexible connection comprises resilient elements held by fastening means between end plates.

Preferably, the fastening means has tightening means for adjusting the flexible connection to a pre-determined compression setting of the resilient elements.

The invention further discloses a vehicle having an impacting apparatus as previously described.

### BRIEF DESCRIPTION OF THE DRAWINGS

In order that the invention may be more clearly understood, the preferred embodiment thereof will now be described in detail by way of example, with reference to the accompanying drawings, in which:

FIG. 1 is a side view of a vehicle having a vibratory impactor according to the invention attached to an end of an articulated arm or boom,

FIG. 2 is an elevational perspective view of the vibratory impactor of FIG. 1,

FIG. 3 is a side view of the vibratory impactor of FIG. 1,

FIG. 4 is an end view of the vibratory impactor of FIG. 1,

FIG. 5 is a sectioned side view of a vibration and isolation mount according to the invention,

FIG. 6 is an exploded side view of a vibration and isolation mount according to the invention,

FIG. 7 is a partially sectioned exploded end view of the vibration and isolation mount of FIG. 6,

FIG. 8 is a side view of a vibratory impactor pointed tool according to one embodiment of the invention,

FIG. 9 is a top view of the vibratory impactor pointed tool according to FIG. 8,

FIG. 10 is an elevational perspective view of a vibratory impactor pointed tool according to a further embodiment of the invention,

FIG. 11 is a side view of a vibratory impactor pointed tool of FIG. 10,

FIG. 12 is an end view of the vibratory impactor pointed tool of FIG. 10, and

FIG. 13 is a top view of the vibratory impactor pointed tool according to FIG. 10.

### DETAILED DESCRIPTION OF THE INVENTION

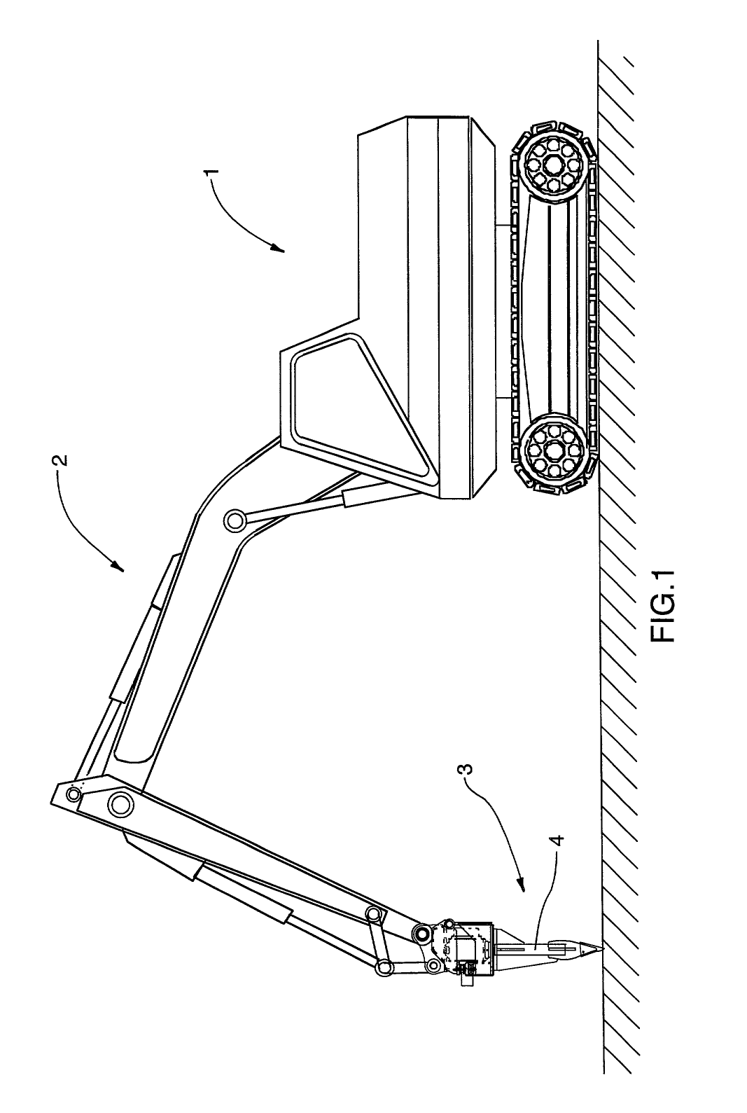

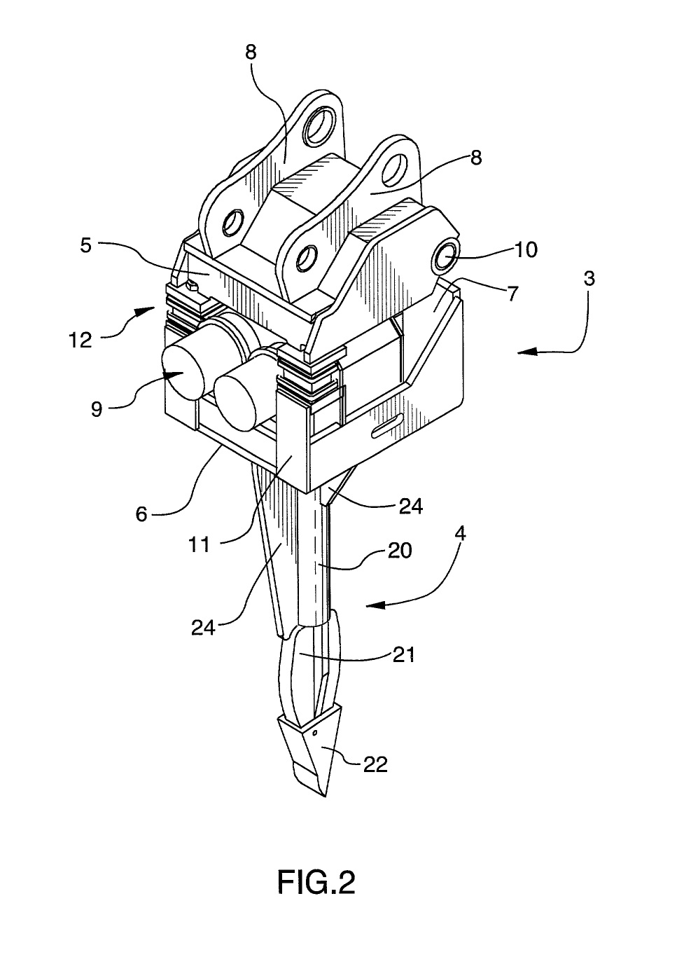

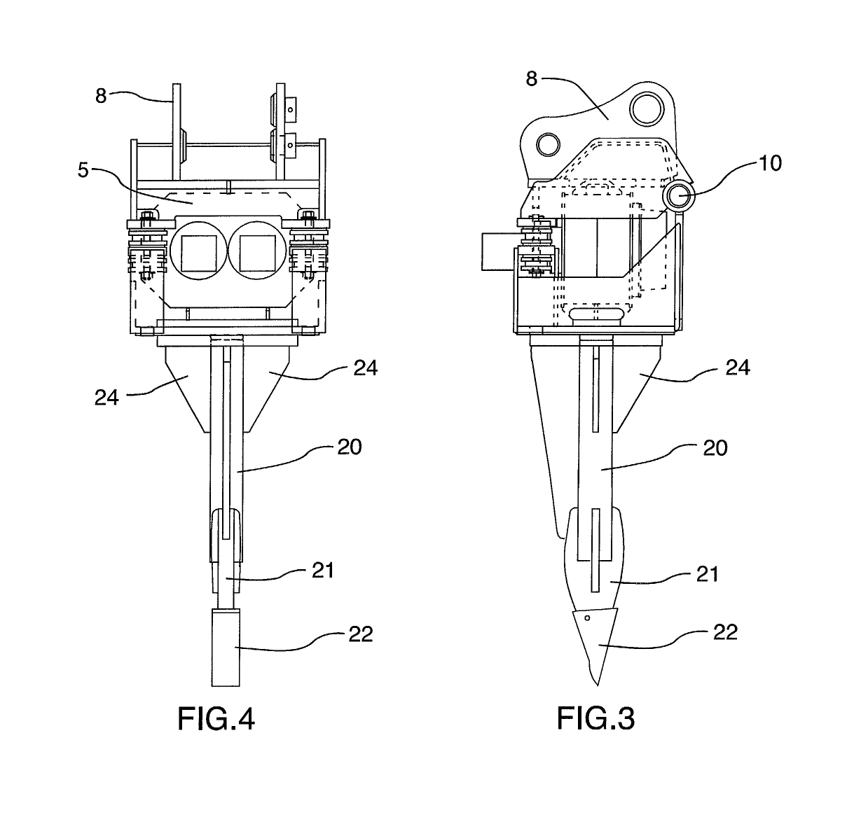

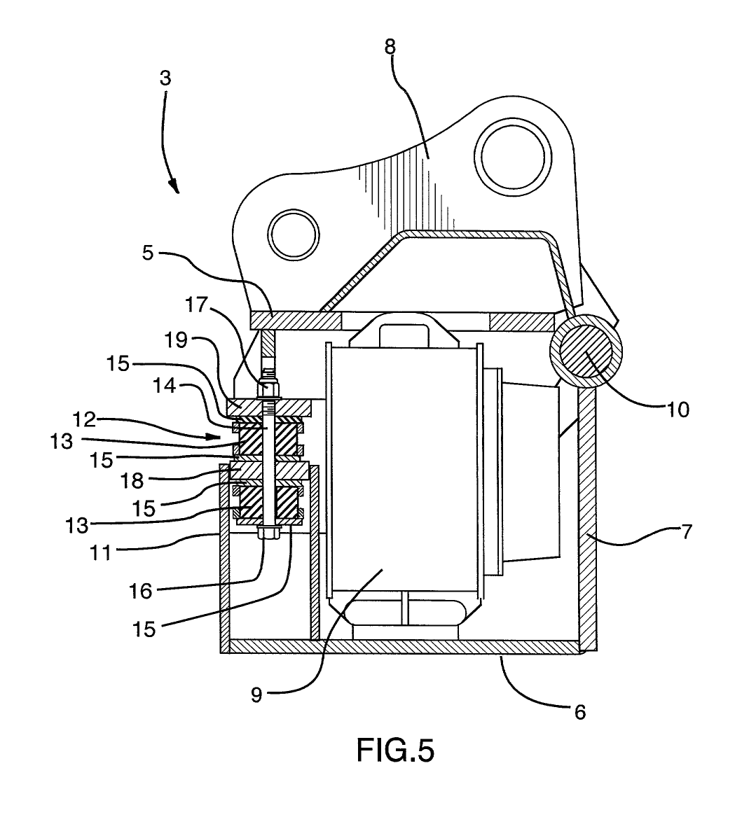

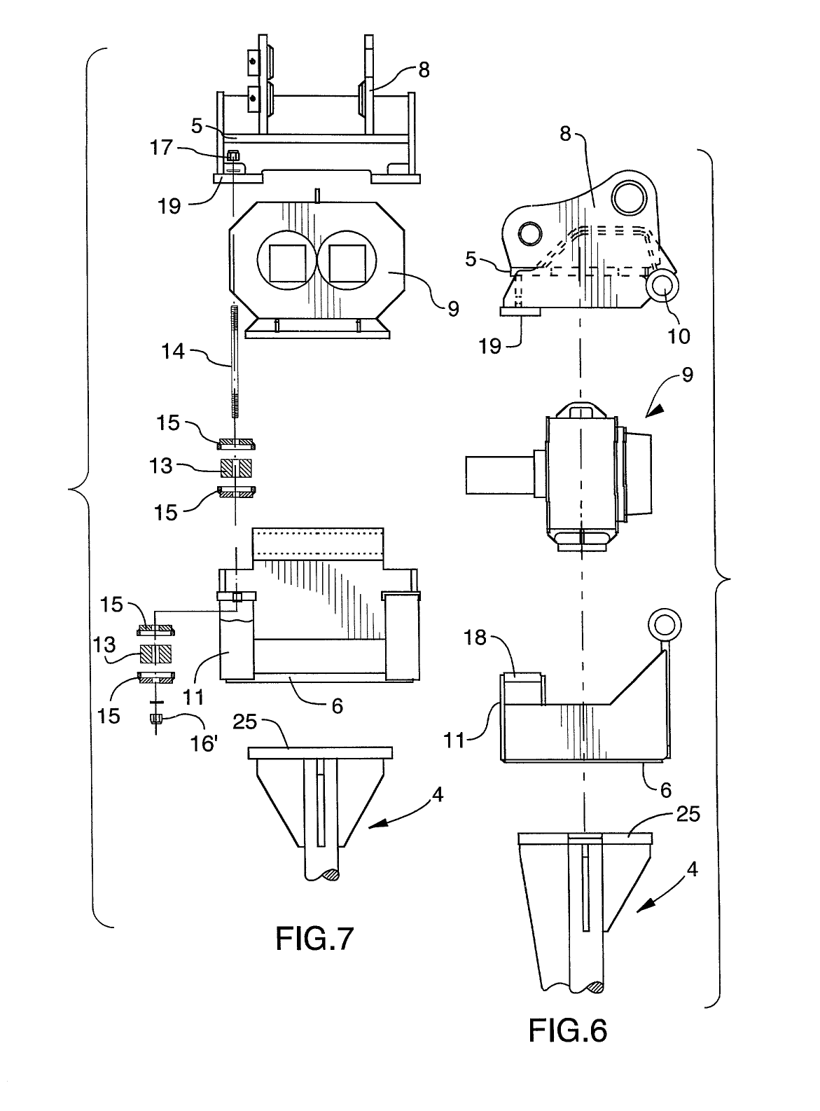

FIG. 1 shows a vehicle 1 having an articulated arm 2 on which a tool holder 3 is mounted. The tool holder mounts a vibrating replaceable tool 4, which is the actual material working part. As shown in FIGS. 2 to 7, the tool holder generally has an arm mounting portion 5, for attachment to the vehicle articulated arm 2, and a tool support portion 6, on which the vibrating replaceable tool is mounted. The arm mounting portion has arm attachment means 8, which are shaped to comply with the actual requirements for the particular arm used.

A vibrator 9 is arranged on the tool holder 3 to cheaply and efficiently impart vibrations to the tool support portion 6. The tool support portion 6 is pivotably attached to the arm mounting portion 5 via a first edge 7 of the tool support portion, via a pivot 10 . The pivoting arrangement directs the vibration movement of the tool in a generally up-and-down motion, when the tool is pointing down. The efficiency of the tool in working material is thus greatly enhanced. The tool support portion is further flexibly connected at a second edge 11 of the tool support portion to the arm mounting portion 5 via a flexible connection 12 remote from the pivot. The flexible connection preferably has resilient elements 13 held by a bolt 14, or similar fastening means, between end plates 15. The bolt has a head 16 at one end and a nut 17 at the opposite end, for tightening the flexible connection to a pre-determined compression setting of the resilient elements. Alternatively, nuts can be used at both ends for even greater adjustment possibilities, i.e. a nut 17 and a nut 16′ is used as shown in FIG. 7. The vibration dampening properties of the flexible connection can thus be set. The flexible connection 12 is held on the second edge 11 by a first attachment plate 18, and on the arm mounting portion 5 by a second attachment plate 19. Thus, the vibrating replaceable tool 4 of the tool holder 3 is set in vibration movement by the vibrator 9. The vibrations are to the most part isolated from being transplanted to the arm 2 by the vibration dampening provided by the tool holder being hingedly supported by the pivot 10 and the vibration dampening of the flexible connection 12.

A first embodiment of a vibrating replaceable tool 4 of the tool holder 3 is shown in FIGS. 2 to 4. The tool has an elongated substantially cylindrical body 20 with a tip 21 having a pointed end 22 for material treatment (removal, breaking etc.). Opposite the tip, the body has a mounting end 23, which preferably is removably mounted on a replacement attachment plate 25, for instance using first mounting holes 27 (see FIGS. 9, 10 and 13). Reinforcement plates 24 are preferably arranged around the circumference of the mounting end to add stability to the mounting of the mounting end to the replacement attachment plate. The replacement attachment plate is preferably mounted to the tool support portion 6 of the tool holder via second mounting holes 26 (see FIGS. 9, 10 and 13).

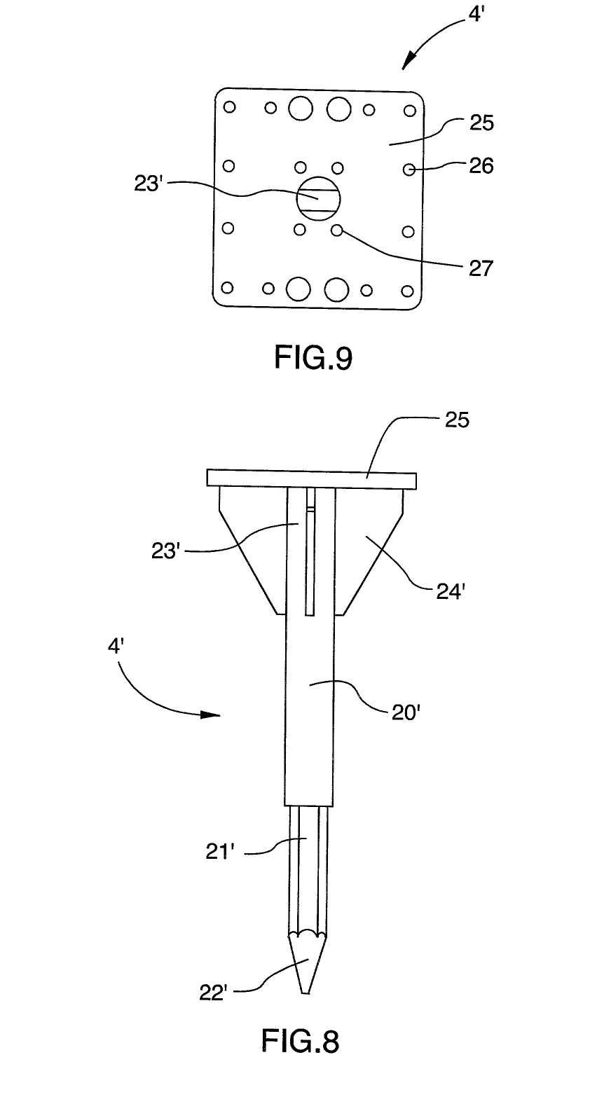

A second embodiment of a vibrating replaceable tool 4′ of the tool holder 3 is shown in FIGS. 8 and 9. The tool has an elongated substantially cylindrical body 20′ with a tip 21′ having a pointed end 22′ for material treatment (removal, breaking etc.). Opposite the tip, the body has a mounting end 23′, which preferably is removably mounted on a replacement attachment plate 25, for instance using first mounting holes 27. Reinforcement plates 24′ are preferably arranged around the circumference of the mounting end to add stability to the mounting of the mounting end to the replacement attachment plate. The replacement attachment plate is preferably mounted to the tool support portion 6 of the tool holder via second mounting holes 26.

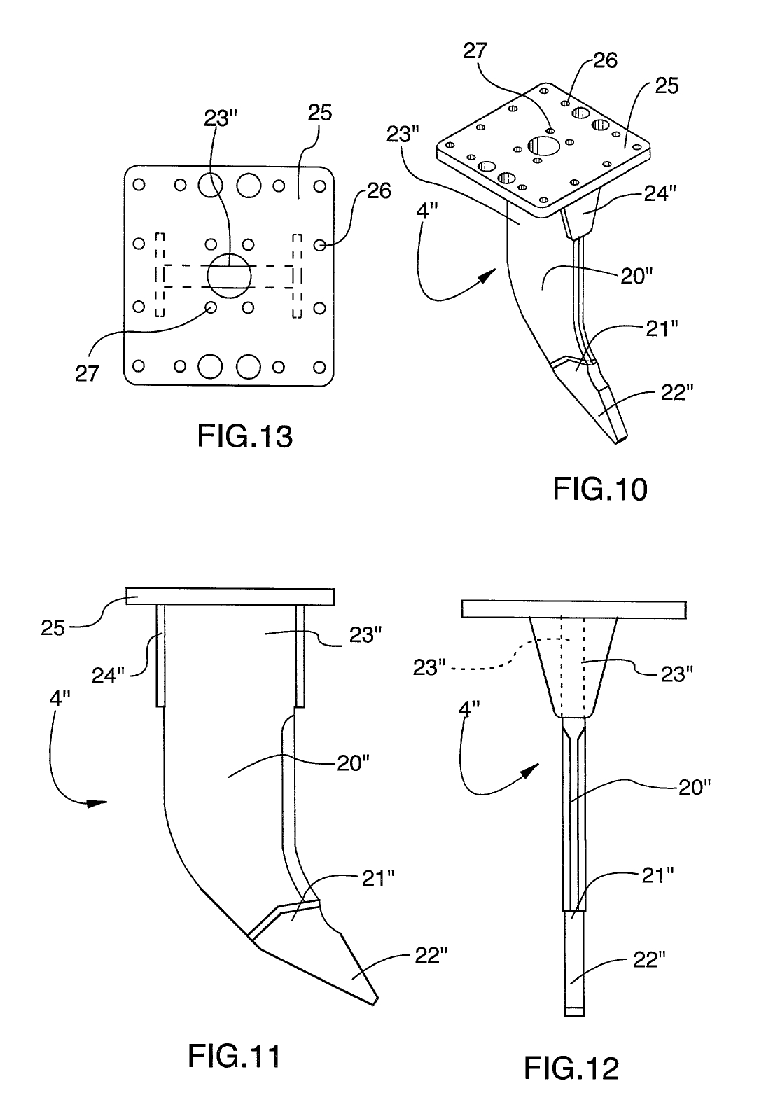

A third embodiment of a vibrating replaceable tool 4″ of the tool holder 3 is shown in FIGS. 10 to 13. The tool has an elongated substantially flat body 20″ with a curved tip 21″ having a pointed end 22″ for material treatment (removal, breaking etc.). Opposite the tip, the body has a mounting end 23″, which preferably is removably mounted on a replacement attachment plate 25, for instance using first mounting holes 27. Reinforcement plates 24″ are preferably arranged at the sides of the mounting end to add stability to the mounting of the mounting end to the replacement attachment plate. The replacement attachment plate is preferably mounted to the tool support portion 6 of the tool holder via second mounting holes 26.

It will be appreciated that the above description relates to the preferred embodiments by way of example only. Many variations on the invention will be obvious to those knowledgeable in the field, and such obvious variations are within the scope of the invention as described and claimed, whether or not expressly described.

1. An impacting apparatus, for a vehicle, comprising:
a mounting portion securable to the vehicle;
a tool support portion pivotally connected adjacent a first edge of said tool support portion to said mounting portion via a pivotal connection and flexibly connected at a second edge of said tool support portion to said mounting portion via a flexible connection remote from said pivotal connection;
vibration means mounted between said mounting portion and said tool support portion for reciprocating said tool support portion relative said mounting portion via said flexible connection; and
a tool extending from said tool support portion.

2. An apparatus according to claim 1, wherein said flexible connection comprises resilient elements held by fastening means between end plates.

3. An apparatus according to claim 2, wherein said fastening means has tightening means for adjusting said flexible connection to a pre-determined compression setting of said resilient elements.

4. A vehicle having an impacting apparatus held by an articulated arm attached to said vehicle, said impacting apparatus comprising:
a mounting portion secured to an end of said arm;
a tool support portion pivotally connected adjacent a first edge of said tool support portion to said mounting portion via a pivotal connection and flexibly connected at a second edge of said tool support portion to said mounting portion via a flexible connection remote from said pivotal connection;
vibration means mounted between said mounting portion and said tool support portion for reciprocating said tool support portion relative said mounting portion via said flexible connection; and
a tool extending from said tool support portion.

5. An apparatus according to claim 4, wherein said flexible connection comprises resilient elements held by fastening means between end plates.

6. An apparatus according to claim 5, wherein said fastening means has tightening means for adjusting said flexible connection to a pre-determined compression setting of said resilient elements.
